(19) United States
(12) Patent Application Publication
(10) Pub. No.: US 2016/0335594 A1
(43) Pub. Date: Nov. 17, 2016

(54) System and Method for Detecting and Reporting Presence of Item in Receiving Box

(71) Applicant: ASD Inc., a PA Corp., Media, PA (US)

(72) Inventors: Martin CZACHOR, JR., Newtown Square, PA (US); Kevin CZACHOR, West Chester, PA (US); Norman FRANKE, Garnet Valley, PA (US); Gary FOSTER, Media, PA (US)

(73) Assignee: ASD INC., A PA CORP., Media, PA (US)

(21) Appl. No.: 14/713,162

(22) Filed: May 15, 2015

(51) Int. Cl. G06Q 10/08; G01V 8/10; G01G 19/00; H04W 4/12; G01N 29/04

(52) U.S. Cl. CPC G06Q 10/0836; H04W 4/12; G01N 29/04; G01G 19/005; G01V 8/10; G01N 2291/101

(57) ABSTRACT

A receiving box receives items for later retrieval by an enterprise. Upon an amount of received items being detected within the receiving box, a report is sent to the enterprise. A detector detects an amount of the received items in the receiving box and outputs a corresponding signal. A controller receives the signal and determines based thereon whether a triggering event has occurred. The triggering event represents that the receiving box has an amount of received items therein such that a person or service should be dispatched from the enterprise to the receiving box to empty same. A reporter is employed by the controller to report the triggering event as a message to the enterprise upon the controller determining that the triggering event has occurred.

### FIELD

The present disclosure relates to a system and method that detects when an item such as mail, a package, a parcel or the like has been deposited in a receiving box such as a post office box, a mailbox, a package container, a drop box, or the like, and that upon detecting the item in the receiving box sends a notification regarding the detected item to a person or service so that the person or service can retrieve the detected item from the receiving box. More particularly, the present disclosure relates to such a system and method whereby the notification is sent remotely to the person or service by way of a wireless communications system.

### BACKGROUND

As may be known, in any enterprise that receives items such as for example mail, packages, parcels, and the like, and particularly where the received items are considered important to the operation of the enterprise, considerable effort is expended in retrieving the received items, especially in the case where the items are received at a location remote from an ultimate destination within the enterprise. For one example, in the case of an enterprise that regularly sends out bills and receives letters with payments for the bills, or in the case of an enterprise that regularly receives letters with requests for goods and/or services, it is often the case that the received letters have been deposited by a postal service in a post office box of the enterprise, where the post office box is physically located within a post office separate from the enterprise. Alternately, it may be that that the received letters have been deposited by the postal service in a private mail box of the enterprise, where the private mail box is physically located within the enterprise but some distance from where the letters are to be processed. For another example, in the case of an enterprise that regularly receives items such as letter, parcels, and packages from senders for delivery to third parties, it may be the case that the enterprise maintains drop boxes at locations proximate the senders so that the senders need not journey to offices of the enterprise to deposit the items for delivery.

An issue arises, however, in that the enterprise that receives the items in the receiving box does not necessarily know that the items have in fact been received with the receiving box. In the case of a post office box or private mail box or the like, it is seldom if ever the case that the enterprise receives any notification from the post office when the items (i.e., mail) are deposited in the box. Although the post office may issue a general statement that mail can regularly be expected in the box by a certain time each day, such a statement is not especially reliable or trusted. Accordingly, an individual from the enterprise may have to journey multiple times to the post office on a daily basis to check whether there is mail in the post office box of the enterprise, or may have to journey multiple times to the private mail box on a daily basis to check whether there is mail therein. Alternately, it may be the case that although the post office deposits mail in the box of the enterprise on an ongoing basis throughout the day, the post office seldom provides trustworthy guidance on when a majority of the mail is to be expected within the box, and again an individual from the enterprise may have to journey multiple times to the box on a daily basis to check whether the majority of the mail has been deposited therein.

In the case of a drop box or the like, it is to be understood that the drop box can be located at a remote site that must be checked by the enterprise most every day, even if the drop box has received no deposited items, in which case the trip to check the drop box has been a waste of resources. Similarly, the drop box can be located at an especially busy site and can fill up quickly, in which case additional items cannot be deposited in the drop box until a trip is made by the enterprise to empty same.

In any case, then, a need exists for a system and method for detecting when an item such as mail, a package, a parcel or the like has been deposited in a receiving box such as a post office box, a private mail box, a package container, a drop box, or the like of an enterprise, and that upon detecting the item in the receiving box sends a notification regarding the detected item to a person or service associated with the enterprise so that the person or service can retrieve the detected item from the receiving box. More particularly, a need exists for such a system and method that detects when the receiving box is occupied by a predetermined amount of deposited items and sends a notification regarding same. Even more particularly, a need exists for such a system and method that sends the notification remotely by way of a wireless communications system.

### SUMMARY

The aforementioned needs are satisfied by a system and method employed in connection with a receiving box within which items are to be deposited for later retrieval by an enterprise. The system and method detect whether an amount of received items have been deposited within the receiving box and reports same to the enterprise. A detector detects an amount of the received items in the receiving box and outputs a signal corresponding to the detected received items.

A controller receives the signal as outputted from the detector and determines based thereon whether a triggering event has occurred. The triggering event represents that the receiving box has an amount of received items therein such that a person or service should be dispatched from the enterprise to the receiving box to empty same. A reporter is employed by the controller to report the triggering event as a message to the enterprise upon the controller determining that the triggering event has occurred.

### BRIEF DESCRIPTION OF THE DRAWINGS

The foregoing summary as well as the following detailed description of various embodiments of the present innovation will be better understood when read in conjunction with the appended drawings. For the purpose of illustrating the various embodiments of the innovation, there are shown in the drawings embodiments that are presently preferred. As should be understood, however, the innovation is not limited to the precise arrangements and instrumentalities shown. In the drawings:

FIG. 1 is a block diagram of an example of a computing environment within which various embodiments of the present innovation may be implemented;

FIG. 2 is a block diagram showing a receiving box within which received items have been deposited and a system for detecting and reporting the received items in accordance with various embodiments of the present innovation;

FIG. 3 is a flow diagram showing actions performed by the detecting and reporting system of FIG. 2 in accordance with various embodiments of the present innovation.

### DETAILED DESCRIPTION OF PREFERRED EMBODIMENTS

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the plural of that term is also contemplated unless circumstances clearly dictate otherwise. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by the relevant public. Although any methods and materials similar or equivalent to those described herein can be used in the practice or testing of the present innovation, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

### Example Computing Environment

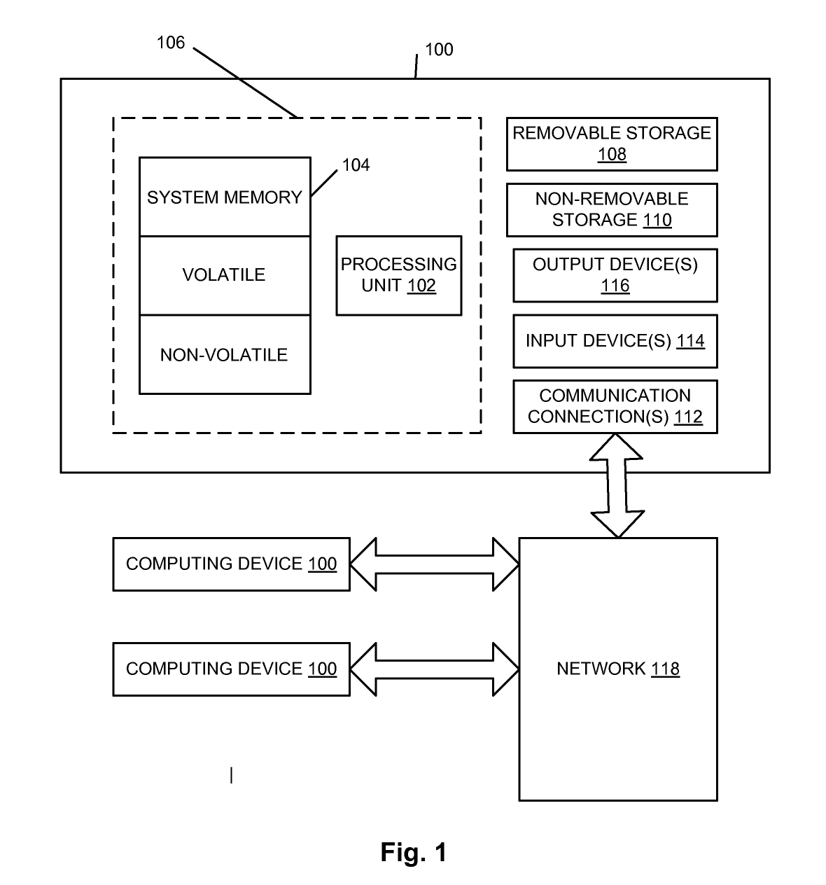

FIG. 1 is set forth herein as an exemplary computing environment in which various embodiments of the present innovation may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (PCs), server computers, handheld or laptop devices including smart phones and computing tablets, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features and functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes or is provided with a variety of computer-readable hardware media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other computer-readable hardware medium which can be used to store the desired information and which can accessed by computing device 100. Any such computer storage media may be part of computing device 100.

Computing device 100 may also contain communications connection(s) 112 that allow the device to communicate with other devices 100. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection (including VoIP), and wireless media such as acoustic, radio frequency (RF), infrared, WiFi, Bluetooth, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. Computing device 100 may also interface with peripheral and other devices, including modems, detectors, signalers, and the like, by way of either analog or digital signals. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like. Likewise, the network 118 may be such an external network.

Particularly in the case where the network 118 is an external network, such network 118 may be a digitally based network (including VoIP) for exchanging computer data among the devices 100, may be an audio and/or video network for exchanging audio and/or video data among the devices 100, or the like. Thus, it may be that the network 118 may be the Internet, a public switched telephone network for landline telephone communications, a mobile switching center for wireless telephone communications, a paging network for distributing paging information, a private multimedia network for establishing videoconferencing, a cellular data network, a WiFi network, or the like. Thus, it should be appreciated that one or more of the computing devices 100 that are shown to the left of the network 118 in FIG. 1 may be a mobile telephone, a landline telephone, a pager, a mobile electronic mail device, a desktop electronic mail device, a mobile electronic texting device, a desktop electronic texting device, or a combination thereof, or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, so-called thumb drives and/or flash drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

### Detecting and Reporting Presence of Item in Receiving Box

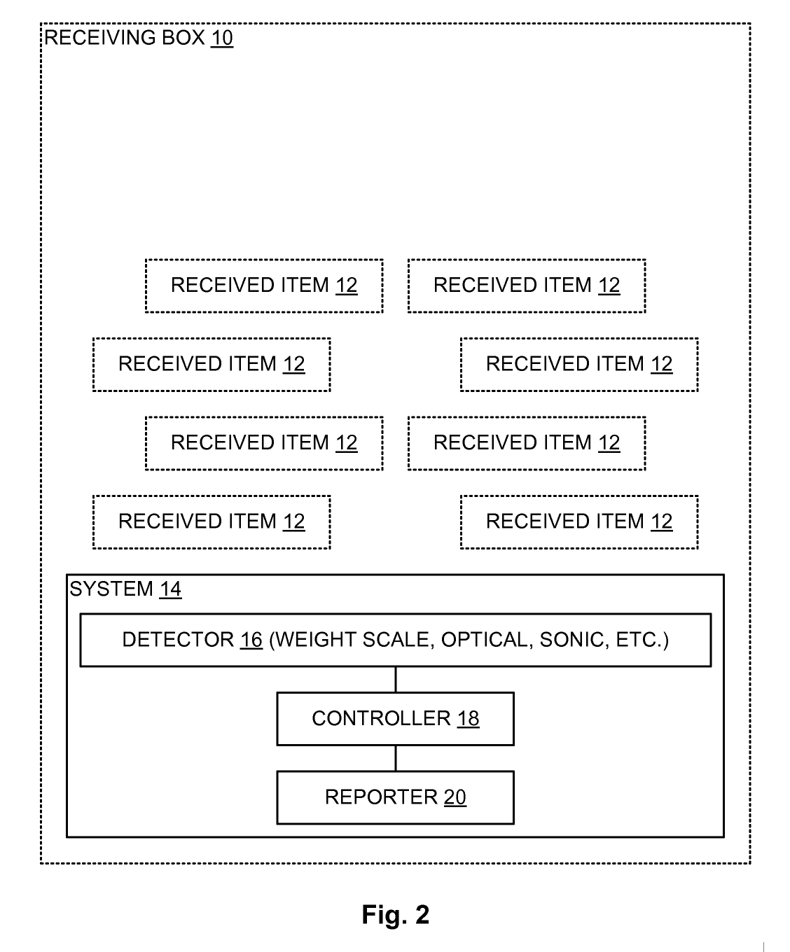

Turning now to FIG. 2, it is seen that an enterprise maintains a receiving box 10 within which items 12 are to be deposited for later retrieval by the enterprise. The enterprise may be most any enterprise without departing from the spirit and scope of the present innovation, although presumptively the enterprise is an organization with a need or desire to have a location at which items 12 are to be received for later retrieval. As was alluded to above, the enterprise may be any sort of organization that receives items 12 as the ultimate destination of such items 12, such as for example a bank, utility, or other firm that receives payments from many customers, a warehouse or other fulfillment center that receives requests from many customers for goods and/or services, or a donation receiving center that receives clothing or other goods. In such instances, the items 12 can be mailed letters and also other types of items 12 such as packages and parcels. As was also alluded to above, the enterprise may alternately be any sort of organization that receives relatively large amounts of items 12 as the deliverer of such items 12 to their ultimate destinations, such as for example a postal service or other letter delivery service, a package delivery service, a parcel delivery service, or the like.

Depending on circumstances, the receiving box 10 may be most any appropriate receptacle for receiving items 12 without departing from the spirit and scope of the present innovation. Typically, although not necessarily, the type, size, and location of the receiving box 10 are determined by the enterprise thereof according to the needs and requirements of the enterprise. Accordingly, if the enterprise is a business that regularly receives payments, the receiving box 10 may be a post office box rented from a post office or a private delivery box rented from a private mail service center, as circumstances may warrant, in which case the receiving box 10 is external to the enterprise. Likewise, the receiving box 10 may be a mail receptacle owned by the enterprise and located internal to the enterprise, although perhaps remote from an area of the enterprise that processes the items 12 received into such receiving box 10. In either instance, it is presently envisioned that the receiving box 10 is relatively smaller, perhaps as little as half a cubic foot of space or so.

In the situation where the enterprise is a business that forwards the received items 12 to an ultimate destination, such as a parcel delivery service, the receiving box 10 may be a drop box or the like that is owned and/or maintained by or on behalf of the enterprise, where the receiving box 10 is positioned in a location to receive parcels, packages, letters, and other items 12 from local businesses, organizations, and other entities to be shipped by the parcel delivery service to their ultimate destinations. In such a circumstance, it is presently envisioned that the receiving box 10 is relatively larger, perhaps as big as thirty cubic feet of space or so.

The received items 12 themselves may of course be any appropriate items without departing from the spirit and scope of the present innovation, presuming of course that the items 12 can be accepted into the receiving box 10. In addition to the aforementioned, letters, parcels, packages, and the like, the received items 12 may also be delivery pouches, shipping containers, luggage, bags, or any other sort of items that are expected to be received in the receiving box 10.

In various embodiments of the present innovation, a detection and reporting system 14 is positioned within the receiving box 10 in order to determine whether an amount of received items 12 have been deposited within the receiving box 10, and if so to report that information to a person or service who is charged with retrieving the received items 12 from the receiving box 10. The system 14 may be any appropriate system without departing from the spirit and scope of the present innovation, presuming that the system 14 provides the functionality required. Mainly, the system 14 includes a detector 16, a controller 18, and a reporter 20, as is shown in FIG. 2.

The detector 16 may be any appropriate detector that detects an amount of the received items 12 in the receiving box 10 without departing from the spirit and scope of the present innovation. In various embodiments, the detector 16 is a weight scale or the like upon which the received items 12 rest upon being deposited within the receiving box 10. The weight scale is presumptively an electronic weight scale that detects the weight of the received items 12 and that outputs a corresponding signal, either pushing the signal toward the controller 18 or periodically being queried for the signal by or on behalf of the controller 18. Presumptively, the weight scale is appropriately positioned within the receiving box 10 such that received items 12 deposited therein rest upon the weight scale. Also presumptively, the weight scale is dimensioned so as to take up a minimal amount of space within the receiving box 10. Such weight scales are known or should be apparent to the relevant public and therefore need not be set forth herein in any detail other than that which is set forth. Notably, in at least some circumstances the weight scale need only detect the presence of non-zero weight without measuring the actual weight, such as for example may be the case if the weight scale is embodied as a weight mat that registers the presence of anything thereon having more than a minimal weight.

The type and meaning of the signal output from the weight scale may be most any type and meaning without departing from the spirit and scope of the present innovation. For example, the signal from the weight scale may represent the actual weight of the received items 12 within the receiving box 10, or may represent that some non-zero weight of received items 12 is present within the receiving box 10, or may represent that some non-zero weight of received items 12 above a predetermined threshold is present within the receiving box 10, or may represent that some increase in weight of received items 12 has been detected, among other things.

Presumptively, the controller 18 is arranged to receive and appreciate the meaning of the signal as outputted from the weight scale/detector 16. Thus, if the signal represents the actual weight of the received items 12 within the receiving box 10, the controller 18 may register such actual weight and act accordingly. In such a circumstance, and in various embodiments, the controller 18 may determine from the actual weight whether a triggering event has occurred. As may be appreciated, such triggering event represents that the receiving box 10 has an amount of received items 12 therein such that a person or service should be dispatched from the enterprise to the receiving box 10 to empty same. As may also be appreciated, such triggering event may be any appropriate triggering event without departing from the spirit and scope of the present innovation. For example, the triggering event may be that the actual weight is any non-zero weight, that the actual weight is some non-zero weight above a predetermined threshold, or that the actual weight has increased by a set amount within a set period of time, among other things.

Similarly, if the signal from the weight scale/detector 16 represents that some non-zero weight of received items 12 is present within the receiving box 10, or if the signal from the weight scale/detector 16 represents that some non-zero weight of received items 12 above a predetermined threshold is present within the receiving box 10, or if the signal from the weight scale/detector 16 represents that some increase in weight of received items 12 has been detected, among other things, the controller 18 may treat the signal as a triggering event in and of itself or may incorporate such signal within an algorithm for determining such a triggering event. As but one example, a triggering event may be defined as when some increase in weight of received items 12 has been detected 10 times in one hour, among other things.

In any circumstance, once a triggering event occurs, as determined by the weight scale/detector 16, the controller 18, or the combination thereof, the controller 18 reports the triggering event as a message or the like to an appropriate person or service by way of the reporter 20. As may be appreciated, the reporter 20 may be any appropriate message-reporting device without departing from the spirit and scope of the present innovation. Typically, although by no means necessarily, the reporter 20 is unable to send the message by way of a wired communications system, and accordingly in various embodiments the reporter 20 includes appropriate functionality therein to employ a wireless communications system to send the message. Such wireless communications system may be any appropriate system for wirelessly sending the message from the controller 18 without departing from the spirit and scope of the present innovation, including a Wi-Fi data system if available, a cellular data system if available, and the like.

The message itself may be most any appropriate message. For example, the message may be a single message or multiple messages that the receiving box 10 needs to be emptied, in the form of a text message or other data string, a voice message delivered to a data address, a voice message delivered to a telephone number as a voice phone call, or the like.

The controller 18 and reporter 20 are to be positioned within the receiving box in an unobtrusive manner so as to not interfere with the weight scale/detector 16. As with the weight scale/detector 16, the controller 18 and reporter 20 should be dimensioned so as to take up a minimal amount of space within the receiving box 10. In various embodiments of the present innovation, the controller 18 and the reporter 20 are embodied within a single device, such as a smart phone or smart non-phone data device that includes an appropriate processor, memory, a battery, appropriate communications functionality, and other appropriate processing functionality.

Notably, such a smart phone or smart non-phone data device is self-contained, can provide power to the weight scale/detector 16 if need be, and likely includes sufficient battery power to operate for multiple days if not weeks. However, such data device may not be amenable to providing the functionality required, and/or may draw excessive amounts of power for other functionality not necessary for the system 14. If so, the functionality needed may be distilled down to a purpose-built device without departing from the spirit and scope of the present innovation. Notably, such a purpose-built device need not necessarily include a viewing/input screen, which can draw power excessively. In various embodiments, such a purpose-built device need only include a micro-controller (as the controller 18) connected to a cellular and/or Wi-Fi modem (as the reporter 20) and integrated with a connector for interfacing with the weight scale/detector 16. If powered by a lithium ion battery or the like, the purpose-built device might be expected to need recharging or replacement on a monthly basis.

Although thus far set forth as a weight scale, the detector 16 may alternately be an optical detector without departing from the spirit and scope of the present innovation. As may be appreciated, such an optical detector 16 would detect when the receiving box 10 fills above a certain level, and could be instantiated as an infra-red or laser emitter-receiver pair that creates an optical beam which is broken when the received items 12 in the receiving box 10 grow to a height that interrupts the optical beam. The level at which the optical beam is broken may be any appropriate level without departing from the spirit and scope of the present innovation. For example, if the receiving box 10 is to be emptied only when full, the level might be set to 90 percent of the internal height of the receiving box, while if the receiving box 10 is to be emptied when more than a minimal amount of received items 12 have been placed thereinto, the level might be set to 15 percent of the internal height of the receiving box 10. Such an infra-red or laser emitter-receiver pair and optical beam and the use thereof is known or should be apparent to the relevant public and therefore need not be set forth herein in any detail other than that which is set forth.

Also, the detector 16 may alternately be a sonic detector without departing from the spirit and scope of the present innovation. As may be appreciated, such a sonic detector 16 would detect when the receiving box 10 fills beyond a certain level, and could be instantiated as a sonic transducer that emits and receives an ultrasonic sound burst or the like. As is known such an ultrasonic sound burst changes noticeably within an enclosed space as the space is filled in. The amount of space filled before the receiving box 10 is to be emptied may be any appropriate amount without departing from the spirit and scope of the present innovation. For example, if the receiving box 10 is to be emptied when half full but the box 10 is remotely located, the amount might be set to 40 percent. Such sonic transducer and the use thereof is known or should be apparent to the relevant public and therefore need not be set forth herein in any detail other than that which is set forth.

Notably, such optical detector 16 or sonic detector 16 might be considered to work better in a larger receiving box 10, where an appropriate weight scale/detector 16 might be considered to be too large or unwieldy. That said, the optical detector 16 or sonic detector 16 may draw more power than a weight scale/detector 16. If the drawn power becomes excessive, it may be that the controller 18 controls the optical detector 16 or sonic detector 16 to operate intermittently, perhaps only once every 15 minutes. In various embodiments of the present innovation, the system 14 conserves power by operating only intermittently, again perhaps only once every 15 minutes, if need be, and regardless of whether the detector 16 is a weight scale/detector 16, an optical detector 16, a sonic detector 16, or otherwise. Also notably, if the detector 16 is operated intermittently, so too may other parts of the system 14 be operated intermittently, such as for example the reporter 20. Operating the detector 16 and reporter 20 as well as other parts of the system 14 intermittently is known or should be apparent to the relevant public and therefore need not be set forth herein in any detail other than that which is provided.

If an optical detector 16 or sonic detector 16 is employed, and similar to before, the type and meaning of the signal output from the detector 16 may be most any type and meaning without departing from the spirit and scope of the present innovation. For example, the signal from the optical detector 16 may represent that the beam has been broken, while the signal from the sonic detector 16 may represent a current amount of space filled in the receiving box 10, among other things.

Again, the controller 18 is presumptively arranged to receive and appreciate the meaning of the signal as outputted from the optical detector 16 or sonic detector 16. Thus, if the signal represents that the beam has been broken, the controller 18 may act accordingly by treating the signal as the triggering event representing that a person or service should be dispatched from the enterprise to the receiving box 10 to empty same. Likewise, if the signal represents a current amount of space filled in the receiving box 10, the controller 18 may record the signal and accumulate signals until the signals cumulatively form a triggering event in which a person or service should be dispatched from the enterprise to the receiving box 10 to empty same. As may again be appreciated, such triggering event may be any appropriate triggering event without departing from the spirit and scope of the present innovation. In any circumstance, and again, once a triggering event occurs, the controller 18 reports the triggering event as a message or the like to an appropriate person or service by way of the reporter 20.

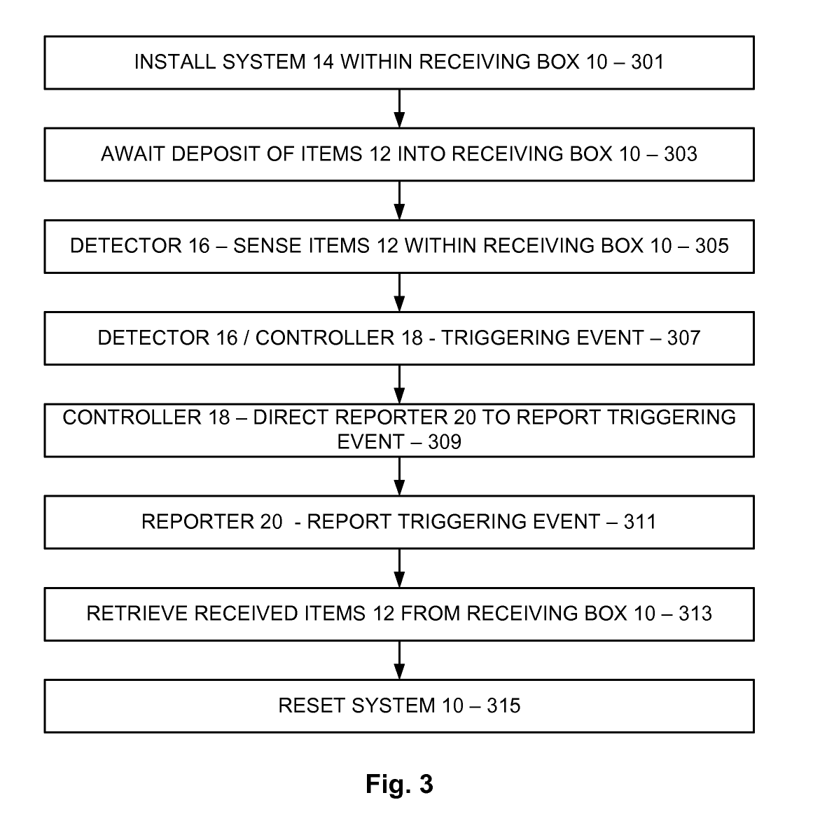

Turning now to FIG. 3, the system 14 of the present innovation is employed in the following manner. Preliminarily, the system 14 is appropriately installed within the receiving box 10 of the enterprise (301). Such installation varies according to the particulars of the receiving box 10, the items 12, and the type of detector 16, but such installation should be apparent to the relevant public and therefore need not be set forth herein in any detail other than that which is provided. Generally, however, the system 14 is to be installed both to reliably sense the presence of received items 12 in the receiving box, and also to cause triggering events in a desired manner.

Once installed, the system 14 awaits the deposit of received items 12 into the receiving box 10 (303). As was alluded to above, such waiting may involve continuously sensing whether the items 12 have been deposited into the receiving box 10, or intermittently sensing whether the items 12 have been deposited into the receiving box 10. Although thus far disclosed as reporting when a triggering event has occurred, the reporter 20 of the system 14 may also report intermediate events such as status events and the status of the system 14 itself, among other things. As may be appreciated, such status events may include a current amount of space available or a current weight of received items 12 within the receiving box 10, among other things, and the status of the system 14 may include a current battery charge and whether the controller 18 has experienced any errors, among other things.

At some point, items 12 are in fact deposited within the receiving box 10 and the system 14 senses same by way of the detector 16 (305). Note here that the deposit of an item 12 in the receiving box as at 305 may or may not cause a triggering event, depending on how a triggering event is defined and how the detector 16 and controller 18 are arranged and/or programmed to perceive such triggering event. As should now be appreciated, it may be that a triggering event occurs upon the deposit of a single item 12 into the receiving box 10, or that a triggering event occurs only when the receiving box 10 is almost full with received items 12, among other things.

Nevertheless, at some instance the detector 16 and/or the controller 18 conclude that a triggering event has taken place (307), and based thereon the controller 18 directs the reporter 20 to report the triggering event (309). Thereafter, and as should be appreciated, the reporter 20 in fact reports the triggering event and perhaps associated details to a person or service associated with the enterprise (311). Such associated details may include most any details, and for example may include a date and time of the triggering event, a location of the receiving box 10, and a type of the triggering event if multiple triggering events are available, among other things. Presumptively, the person or service then journeys to the receiving box 10 and retrieves the received items 12 as deposited therein (313).

In the event that the triggering event as reported by the reporter 20 is not responded to in a reasonable period of time, it may be the case that the reporter 20 again reports the triggering event as at 311, and/or reports the triggering event to another person or service associated with the enterprise. Correspondingly, upon retrieval of the received items 12 as at 313, the system 14 is reset (315). Resetting such system 14 may occur manually upon the person or service appropriately actuating same, or may occur automatically upon the detector 16 and/or controller 18 sensing that the receiving box is either empty or at least less full, or may occur automatically in the normal course of operation of the system 14.

### CONCLUSION

The programming believed necessary to effectuate the processes performed by the system 14 and related components in connection with the various embodiments of the present innovation is relatively straight-forward and should be apparent to the relevant programming public. Accordingly, such programming is not attached hereto. Any particular programming, then, may be employed to effectuate the various embodiments of the present innovation without departing from the spirit and scope thereof.

In the present innovation, a system 14 and method are set forth for detecting when an item 12 such as mail, a package, a parcel or the like has been deposited in a receiving box 10 such as a post office box, a private mail box, a package container, a drop box, or the like of an enterprise. Upon detecting one or more of the items 12 in the receiving box 10 and upon a triggering event, a reporter 20 of the system 14 sends a notification regarding the detected items 12 to a person or service associated with the enterprise so that the person or service can retrieve the detected items 12 from the receiving box 10. The system 14 and method may detect when the receiving box 10 is occupied by a predetermined amount of deposited items 12, and send a notification regarding same. The reporter 20 of the system 14 and method sends the notification remotely by way of a wireless communications system.

It should be appreciated that changes could be made to the embodiments described above without departing from the innovative concepts thereof. For example, although the present innovation is set forth primarily in terms of a wireless communications system, a wired communications system may alternately be employed if available. Likewise, although the present innovation may be set forth with reference to certain types of items 12, differing circumstances may necessitate differing types of items 12, perhaps with suitable modification. It should be understood, therefore, that this innovation is not limited to the particular embodiments disclosed, but it is intended to cover modifications within the spirit and scope of the present innovation as defined by the appended claims.

1. A system employed in connection with a receiving box within which items are to be deposited for later retrieval by an enterprise, the system for detecting whether an amount of received items have been deposited within the receiving box and for reporting same to the enterprise, the system comprising:
a detector for detecting an amount of the received items in the receiving box and for outputting a signal corresponding to the detected received items;
a controller for receiving the signal as outputted from the detector and for determining based thereon whether a triggering event has occurred, the triggering event representing that the receiving box has an amount of received items therein such that a person or service should be dispatched from the enterprise to the receiving box to empty same; and
a reporter for being employed by the controller to report the triggering event as a message to the enterprise upon the controller determining that the triggering event has occurred.

2. The system of claim 1 wherein the receiving box is one of a post office box acquired from a post office and a private delivery box acquired from a private mail service center, and wherein the received items include letters for the enterprise.

3. The system of claim 1 wherein the detector is a weight scale positioned within the receiving box, the received items resting upon the weight scale within the receiving box, the signal output from the weight scale representing one of an actual weight of the received items within the receiving box, that some non-zero weight of received items is present within the receiving box, and that that some non-zero weight of received items above a predetermined threshold is present within the receiving box.

4. The system of claim 1 wherein the detector is a weight scale positioned within the receiving box, the received items resting upon the weight scale within the receiving box, and wherein the controller determines based on the signal as outputted from the weight scale detector that a triggering event has occurred, the triggering event being one of that an actual weight of the received items are present within the receiving box, that some non-zero weight of received items is present within the receiving box, and that that some non-zero weight of received items above a predetermined threshold is present within the receiving box.

5. The system of claim 1 wherein the reporter sends a data message to a data address of the enterprise by way of a wireless communications system.

6. The system of claim 1 wherein the controller and the reporter are positioned within the receiving box and are embodied within a single device, the single device being one of a smart phone data device, a smart non-phone data device, and a purpose-built data device.

7. The system of claim 1 wherein the controller and the reporter are positioned within the receiving box and are embodied within a single device that includes a power source, the power source providing power to the detector.

8. The system of claim 1 wherein the controller is embodied within a device that includes a power source, the power source providing power to the detector, the controller controlling the detector to operate intermittently to conserve power.

9. The system of claim 1 wherein the controller is embodied within a device that includes a power source, the power source providing power to the reporter, the controller controlling the reporter to operate intermittently to conserve power.

10. The system of claim 1 wherein the detector is an optical detector positioned within the receiving box, the optical detector for detecting when the receiving box fills with the received items above a predetermined level, and including one of an infra-red and laser emitter-receiver pair that creates an optical beam which is broken when the received items in the receiving box grow to a height that interrupts the optical beam.

11. The system of claim 1 wherein the detector is a sonic detector positioned within the receiving box, the sonic detector for detecting when the receiving box fills beyond a predetermined level, and including a sonic transducer that emits and receives an ultrasonic sound burst which changes noticeably as the receiving box fills with the received items.

12. A method employed in connection with a receiving box within which items are to be deposited for later retrieval by an enterprise, the method for detecting whether an amount of received items have been deposited within the receiving box and for reporting same to the enterprise, the method comprising:
detecting at a detector an amount of the received items in the receiving box;
outputting from the detector a signal corresponding to the detected received items;
receiving at a controller the signal as outputted from the detector and determining based thereon whether a triggering event has occurred, the triggering event representing that the receiving box has an amount of received items therein such that a person or service should be dispatched from the enterprise to the receiving box to empty same; and
reporting at a reporter and at the direction of the controller the triggering event as a message to the enterprise upon the controller determining that the triggering event has occurred.

13. The method of claim 12 wherein the receiving box is one of a post office box acquired from a post office and a private delivery box acquired from a private mail service center, and wherein the received items include letters for the enterprise.

14. The method of claim 12 wherein the detector is a weight scale positioned within the receiving box, the received items resting upon the weight scale within the receiving box, the signal output from the weight scale representing one of an actual weight of the received items within the receiving box, that some non-zero weight of received items is present within the receiving box, and that that some non-zero weight of received items above a predetermined threshold is present within the receiving box.

15. The method of claim 12 wherein the detector is a weight scale positioned within the receiving box, the received items resting upon the weight scale within the receiving box, and wherein the controller determines based on the signal as outputted from the weight scale detector that a triggering event has occurred, the triggering event being one of that an actual weight of the received items are present within the receiving box, that some non-zero weight of received items is present within the receiving box, and that that some non-zero weight of received items above a predetermined threshold is present within the receiving box.

16. The method of claim 12 wherein the reporter sends a data message to a data address of the enterprise by way of a wireless communications system.

17. The method of claim 12 wherein the controller and the reporter are positioned within the receiving box and are embodied within a single device that includes a power source, the method comprising providing power from the power source to the detector.

18. The method of claim 12 wherein the controller is embodied within a device that includes a power source, the method comprising providing power from the power source to the detector and controlling the detector to operate intermittently to conserve power.

19. The method of claim 12 wherein the controller is embodied within a device that includes a power source, the method comprising providing power from the power source to the reporter and controlling the reporter to operate intermittently to conserve power.

20. The method of claim 12 wherein the detector is an optical detector positioned within the receiving box, the method comprising the optical detector detecting when the receiving box fills with the received items above a predetermined level, the optical detector including one of an infra-red and laser emitter-receiver pair that creates an optical beam which is broken when the received items in the receiving box grow to a height that interrupts the optical beam.

21. The method of claim 12 wherein the detector is a sonic detector positioned within the receiving box, the method comprising the sonic detector detecting when the receiving box fills beyond a predetermined level, the sonic detector including a sonic transducer that emits and receives an ultrasonic sound burst which changes noticeably as the receiving box fills with the received items.
